(19) United States
(12) Patent Application Publication
(10) Pub. No.: US 2006/0272129 A1
(43) Pub. Date: Dec. 7, 2006

(54) Friction hinge with viscous damping

(75) Inventors: Edward T. Rude, Columbia, MD (US); Walter Brokowski, Stamford, CT (US)

Correspondence Address: GOTTLIEB RACKMAN & REISMAN PC, 270 MADISON AVENUE, 8TH FLOOR, NEW YORK, NY, 100160601, US

(73) Assignee: TorqMaster, Inc., Stamford, CT (US)

(21) Appl. No.: 11/341,987

(22) Filed: Jan. 27, 2006

Related U.S. Application Data
(60) Provisional application No. 60/687,483, filed on Jun. 4, 2005.

(51) Int. Cl. E05D 11/08

(52) U.S. Cl. 16/342

(57) ABSTRACT

A hinge assembly rotationally connecting two components includes at least a shaft coupled to one of the components and a tubular member connected to the other component and a defining an annular space around said shaft. A viscous damping fluid is disposed in said space and provides a damping force resisting relative rotation between the two components. A second tubular member is also provided that is connected to the shaft and is arranged axially around the first tubular member. In this latter configuration, static and dynamic frictional forces are generated between the tubular members that resist rotation between the components as well.

### RELATED APPLICATIONS

The subject matter of this application is related to our commonly owned U.S. patent application Ser. No. ______ filed ______ based on U.S. Provisional application No. 60/687,483, file Jun. 4, 2005, entitled Friction Hinge with Angularly Dependent Torque; and U.S. Patent publication entitled Reinforcer For Wrapped Band Hinges, No. 20050028321, published Feb. 10, 2005, both incorporated herein by reference.

### BACKGROUND TO THE INVENTION

a. Field of Invention

This invention pertains to a novel hinge in which two cylindrical surfaces are separated by a space that is filled with a viscous damping fluid to generate a frictional force between the two surfaces that is proportional to the relative rotational speed of the two surfaces. Other surfaces are provided in the hinge that generate static and dynamic frictional forces controlling the movement of various hinge elements.

b. Description of the Prior Art

Friction hinges are now found in many products. Often they are used to hold display screens in position in laptop computers, video displays in automobiles, medical equipment and the like. The friction hinges in these devices have improved greatly within the past few years and do an excellent job of holding their displays in position. However, their performance is less then ideal because the static coefficient of friction between any two contacting elements is always substantially larger then the dynamic coefficient despite efforts to make the difference as small as possible. The result of this is that the device being controlled by the friction hinge, once in motion, tends to keep moving. This can result in laptop lids that slam shut and video screen in cars that swing too freely from their overhead mounts. This can be merely annoying or it can cause damage to the video screen or to its mountings.

### SUMMARY OF THE INVENTION

Our invention provides a friction hinge with viscous, and therefore velocity dependent damping. When stationary, the inventive hinge has the well known characteristics of friction hinges. In rotation, the hinge displays the characteristics usually associated with viscous damping and, therefore, provides a damping torque that increases with angular velocity which tends to limit the speed with which the device moves. As the speed of motion decreases, for other reasons, the damping torque also decreases so that the position at which the device comes to rest is more or less independent of the damping torque. However, since the device provides conventional static friction together with viscous damping, and since static friction becomes effective before the relative velocity of moving parts quite reaches zero, the final position will be the angular position at which the velocity is low enough for the static friction to dominate.

In one embodiment, by combining our present invention with a selective friction hinge (described in U.S. patent application Ser. No. ______ filed ______ based on U.S. Provisional application No. 60/687,483, file Jun. 4, 2005, entitled Friction Hinge with Angularly Dependent Torque and incorporated herein by reference), a hinge can be made with wonderful operating characteristics: friction where needed, and viscous damping throughout the range of motion. Furthermore, because these hinges are often employed where space is at a premium, our inventive hinge has the advantage of providing these benefits without requiring significantly greater space than is needed for conventional friction hinges.

Briefly, our inventive viscously-damped friction hinge is constructed of three coaxially disposed elements. There is an annular element which may or may not have cylindrical symmetry according to the geometric requirements of the frictional torque. Of the other two elements, one is disposed inside the annular element, and the other outside it. These two elements are irrotatably connected to one another, effectively giving the device two pieces that can undergo relative rotation. In practice, where the hinge would be used to control the motion and positioning of a screen, either of these can be connected to the screen and the other to its mounting which is usually referred to as ground.

In the preferred embodiment the innermost element is a round shaft. This shaft may be solid, but it could be hollow to form a passage of wires or some other purposes. For simplicity, in what follows, we will refer to the inner element as a solid shaft.

A viscous damping fluid is contained in the space between the inner shaft and the annular element. This fluid can be any of a number of commercially available greases made for this purpose. It is also possible to produce a suitable damping fluid by adding fillers to a lubricating oil to obtain whatever damping characteristics are required for a particular application. Care must be taken to provide smooth surfaces to the shaft and the surfaces of the annular element as close tolerances are needed to achieve useful levels of damping torque. In our experience, it has been necessary to grind the shaft surface and do careful boring of the hole in the annular element.

In the preferred embodiment the outermost element produces friction through its contact with the exterior of the annular element. This friction can be produced by a number of different means that will be well know to those skilled in the art of friction hinges. In our preferred embodiment, friction is produced by means of a question-mark shaped band.

If uniform frictional torque is required throughout the arcuate range of the hinge's motion, then the exterior cylindrical surface of the annular element would be circular. But, according to the teachings of the above-identified U.S. patent application Ser. No. ______), the torque can have an angular dependence with detents as needed.

The object of our invention is to provide a hinge that combines the holding characteristics of friction hinges and which also has the benefits of hydraulically damped motion control when rotating.

Another object of our invention is to provide a hinge that combines friction for positioning and viscous damping for motion control in a small size.

Yet another object of our invention is to provide the frictional and the damping characteristics in a hinge that is compact and yet is easily and firmly attached to each of the elements whose motion is to be controlled thereby.

The inventive pop-up friction hinge system accordingly comprises the features of construction, combination of elements, and arrangement of parts which will be exemplified in the constructions described hereinafter, and the scope of the invention will be indicated in the claims.

### BRIEF DESCRIPTION OF THE DRAWINGS

FIG. 1 is a perspective view of the preferred embodiment of our invention shown with the shaft adapter on the left.

FIG. 2 is a cross-sectional view of the hinge of FIG. 1, taken through the centerline of the hinge.

FIG. 3 is an exploded view of the hinge of FIGS. 1 and 2.

FIG. 4a is an exploded view of an alternative embodiment of our invention depicting another method for the irrotatable attachment of the shaft and the question-mark band, and with an annular element and question-mark shaped band configured to produce an angularly dependent torque.

FIG. 4b shows a cross-sectional view through the hinge of FIG. 4a.

FIGS. 5a and 5b show perspective views of yet another embodiment of the invention depicting a hinge with angularly dependent torque and having an arcuate range without viscous friction.

FIG. 6 is a perspective view of another embodiment of the inventive hinge with the question-mark shaped band mounted to a plate, with the round portion of the band being split into two segments which act as bearings, and a cam segment made a part of the annular element. Friction is generated by the contact between the cam and the mounting plate.

FIGS. 7 and 8 are cut-away views of the hinge of FIG. 6 shown in different angular positions, the cut-away being made to show the interaction of the cam against the plate.

FIG. 9 shows two of our inventive hinges used to mount a video display to an overhead plate.

FIG. 10 shows a further embodiment of the invention with another technique for generating friction.

FIG. 11 represents one possible set of friction elements in a hinge of the type shown in FIG. 1 FIG. 12 depicts another type of friction hinge adapted for use in the hinge of FIG. 10.

FIG. 13 is an exploded view of a version of the invention in which viscous damping occurs outside of the middle element, and friction is generated on its interior surface.

### DETAILED DESCRIPTION OF THE INVENTION

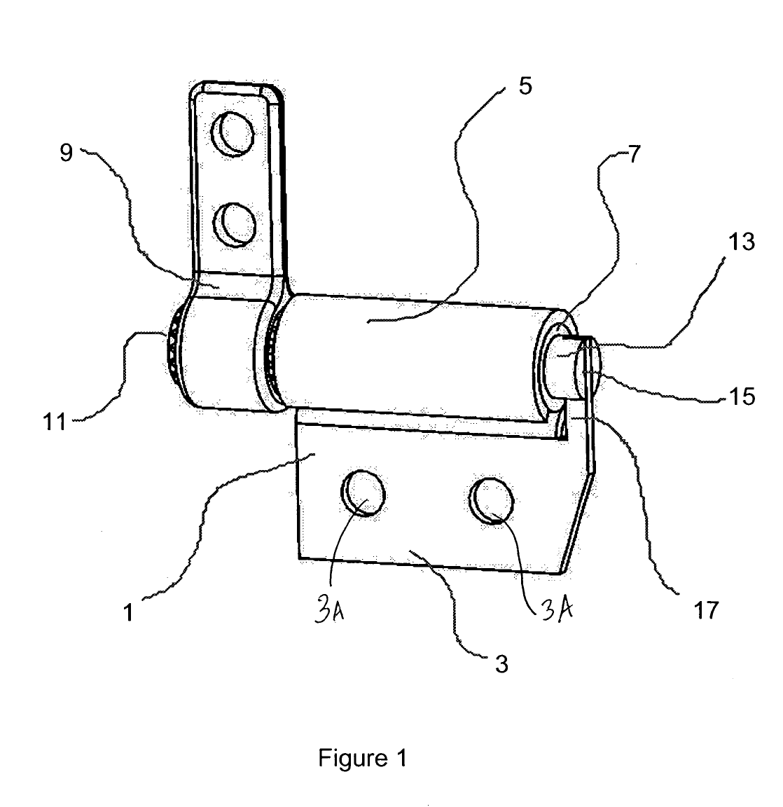

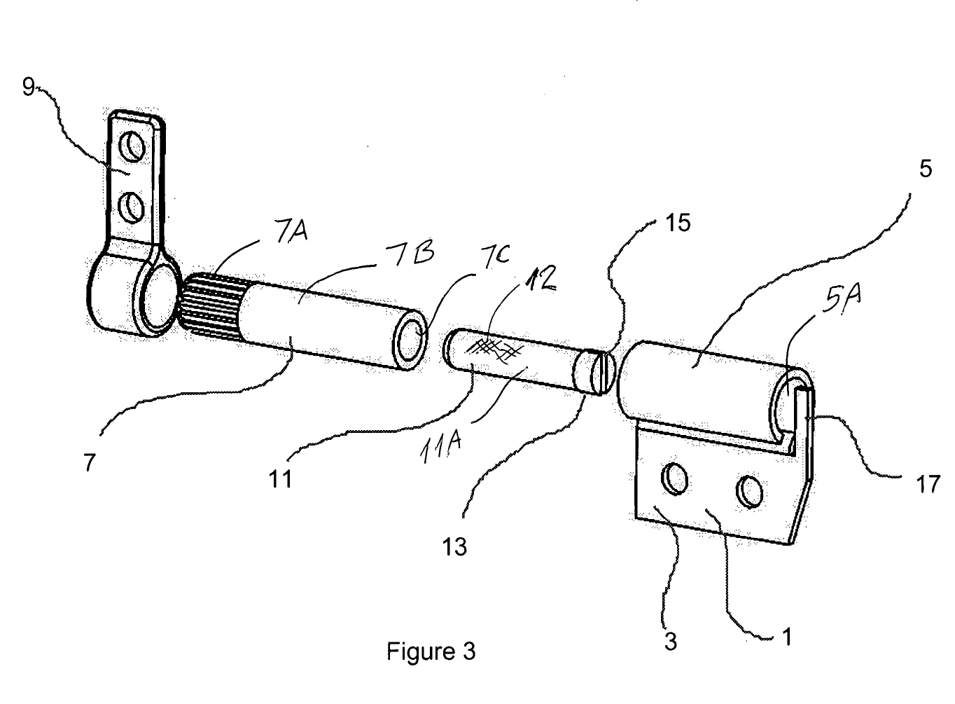

Referring now to FIGS. 1, 2, and 3, the subject hinge includes a question-mark shaped band 1 with a mounting flange 3 (visible only in FIGS. 1 and 3), a circular portion 5, a sleeve or annual element 7 and a shaft 11. The flange 3 is formed with a plurality of holes 3A for mounting to one of the components to be connected by the hinge of our invention. Though shown as flat, the flange 3 can be formed to any other convenient shape. Similarly, the number, size and shape of the mounting holes 3A can changed as needed. Moreover, instead of flange 3 other firm mounting means can be employed.

The circular portion 5 is formed to a slightly smaller size than the outside diameter of annular element 7. The difference between the respective sizes of these two components determines the frictional torque generated therebetween. In assembly, band 1 is pressed over annular element 7. Relative rotation of one of these with respect to the other will, according to the well know principles of friction hinges, require overcoming the frictional torque produced by the interference in their diameters. Relative rotation in the direction so as to tighten the band around annular element 7 produces a higher torque than rotation in the other direction.

As seen in FIG. 3, annular element 7 is a hollow cylinder. One end 7A is knurled to form an irrotatable press fit into adapter 9. Adapter 9 is used as a means for mounting to the other hinged component. The adapter 9 shown is of a commonly used type and configuration, but many different mounting members could be used for securing the hinge between two components without departing from the scope of our invention. Also, the press fit attachment is only by example, and many other firm attachments may be used to couple annular element 7 to a component as well.

Apart from the knurl, annular element 7 has a uniform circular exterior surface 7B. In conjunction with question-mark band 1, this surface 7B produces a torque that is essentially uniform over the full relative rotation of the parts. As will be seen in alternative embodiments, and in accordance with the structures shown in the above-mentioned patent application, the annular element 7 can have an outer surface 7 with a non-uniform shape to produce variations in torque, and even detent positions according to the details of that shape.

Annular element 7 is hollow and is formed with an interior surface 7C to accept shaft 11. Shaft 11 has an outer surface 11 A coated with the viscous damping fluid 12 before insertion into annular element 7 so as to fill the space between the respective surfaces 7C, 11A. The diametrical clearance between surface 11A and the inside surface 7C, together with the shear characteristics of the viscous damping fluid used, are selected to provide damping. We have found that the clearance between surfaces 7C and 11A should be in the range of 0.5 and 1.5 mills.

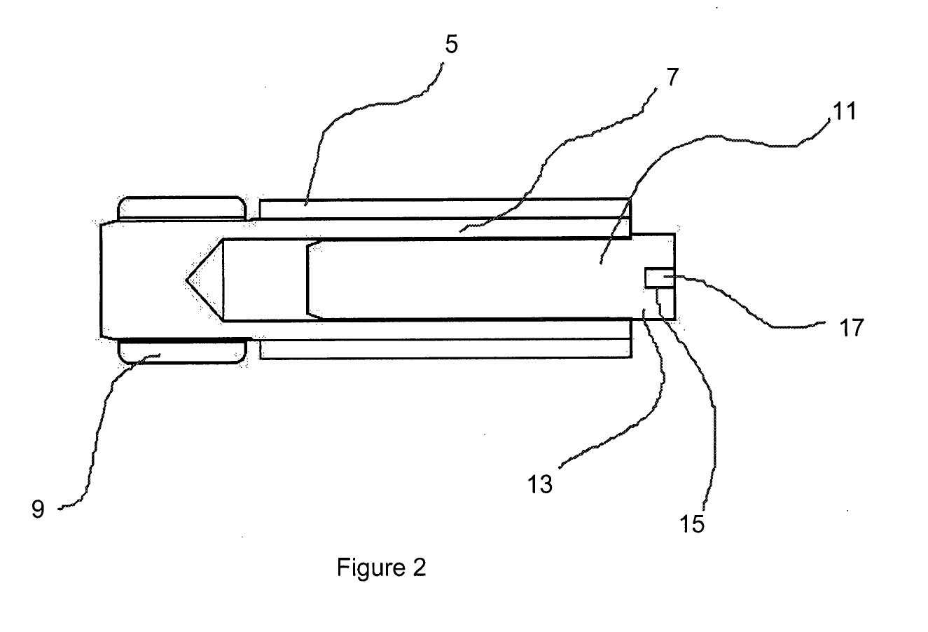

It may be convenient to include a shoulder 13 on shaft 11 to limit the axial movement of annular element 7 in one direction as best seen in FIG. 2. In this embodiment, there is nothing to limit the excursion of annular element in the other direction. It is not difficult to include a feature to accomplish that. But, as these hinges are most often used in pairs, with both attached to the same lid and base, it is usually sufficient to limit the travel in one direction only, and depend upon the other hinge, which can be mounted in the opposite orientation, to limit travel in the second direction.

The shoulder end 13 of shaft 1 has cross slot 15. Extending from mounting flange 3 is anti-rotation arm 17 which fits into slot 15 to cause band 1 and shaft 11 to rotate together.

In operation, annular element 7 rotates relative to and between band 1 and shaft 11. Friction is produced between the circular portion 5 of question-mark band 1 and the exterior surface of annular element 7. In other words, annular element 7 and band 5 cooperate to generate static and dynamic friction therebetween in the usual manner. However, while these two elements rotate with respect to each other, the annular element 7, the shaft 11 and the damping fluid 12 cooperate to generate a velocity-dependent, viscous damping torque or force between the interior surface of annular element 7 and shaft 11 which tends to slow the relative rotation. Thus, three kinds of forces are generated within the novel hinge described herein, which limit the movement of the components interconnected by this hinge: a static force generated between the outer surface 7B of annular element 7 and the inner surface 5A of the circular portion 5 of band 1, a dynamic friction generated between the same components, and a velocity-dependant damping force generated between the outer surface 11A of shaft 11 and the inner surface 5A of circular portion 5.

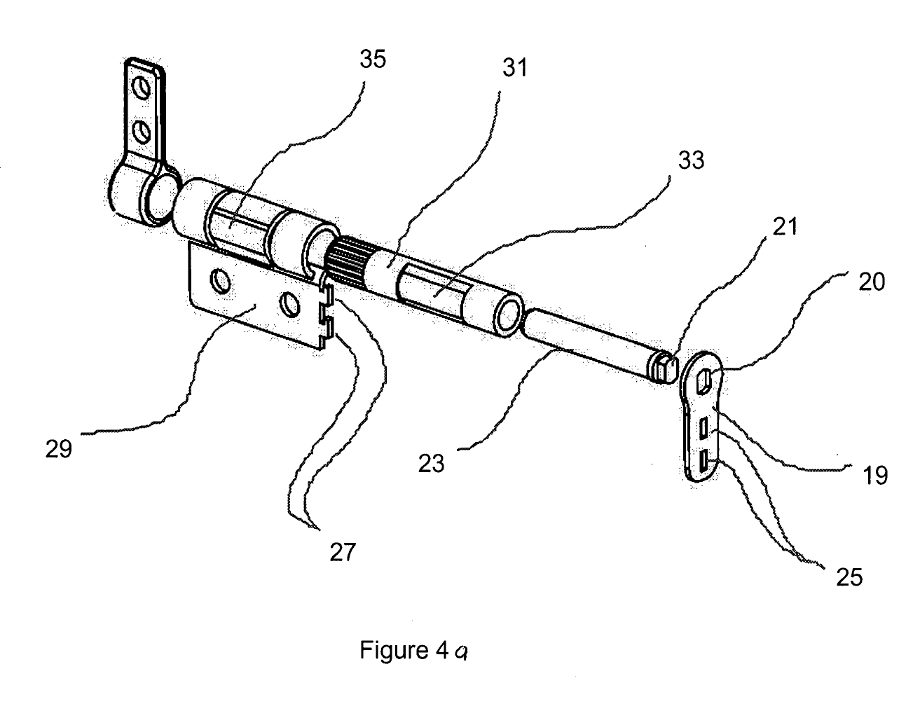

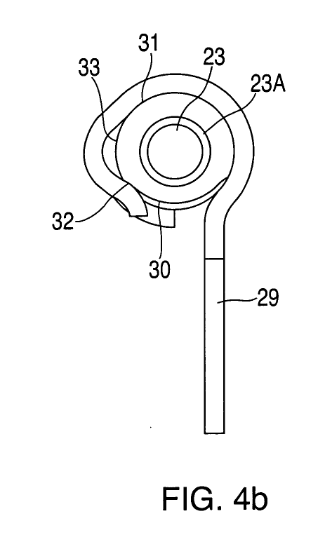

FIGS. 4a and 4b depict a hinge of our invention with the same general construction as the hinge shown in FIGS. 1-3. But this hinge has additional features previously disclosed. First, the attachment of the band to the shaft is done using means disclosed in US Patent publication entitled Reinforcer for Wrapped Band Hinges, No. 20050028321, published Feb. 10, 2005, and incorporated herein by reference. And second, the annular element and the question-mark shaped band are constructed as described in the aforementioned US Patent application entitled Friction Hinge with Angularly Dependent Torque. Anti-rotation arm 19 has a shaped hole 20 made to fit closely over generally oval shaped end 21 of shaft 23. Slots 25 are shaped to receive tabs 27 of band 29 and to lock in place. Annular element 31 has cylindrical surface 33 formed with several zones 30, 32, 33 disposed at different radii from the axis provide angularly dependent torque as described in the latter patent application when combined with shaped portion 35 of band 29. The annular member 31 receives shaft 23 and the space between the member 31 and the shaft 23 is filled with a dampening gel 23A as described above.

In operation, this hinge has the same characteristics as the hinge of the preferred embedment but also in combination with the benefits provided by the other two referenced applications.

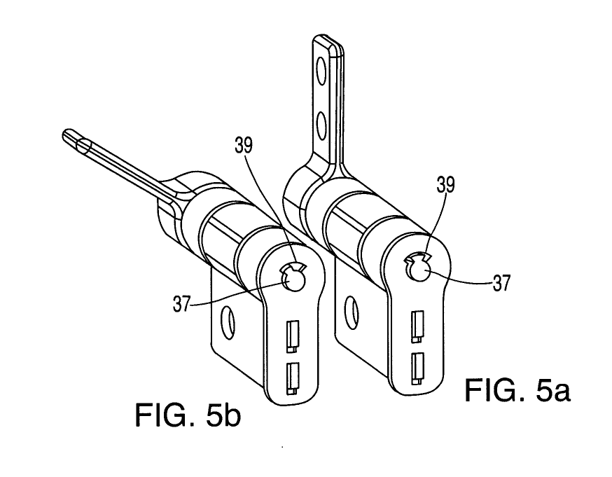

FIGS. 5a and 5b show a hinge of the same general construction as the hinge of FIGS. 4a and 4b. The hinge is shown in two different angular positions. End 37 of the shaft has a key extending from the shaft center. Hole 39 in the anti-rotation arm is shaped to accept end 37 but with clearance for some desired angular displacement that is to take place without viscous damping. FIG. 5a shows the hinge in the center of that angular range, and FIG. 5b shows the hinge at one end of the angular range.

In operation, the hinge has the same characteristics as the hinge of FIGS. 4a and 4b except that each time the direction of rotation is reversed, and there is a range of motion without viscous damping. Thereafter, the viscous damping is resumed, and continues until the next reversal of direction.

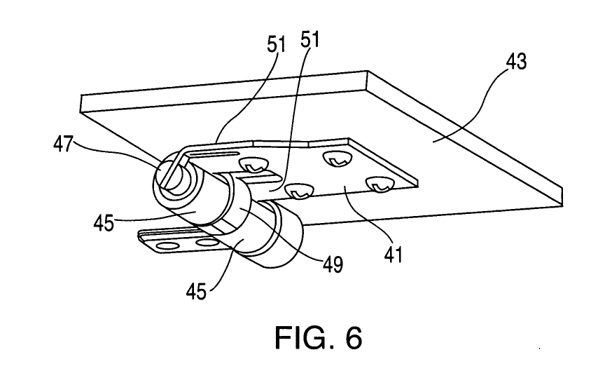

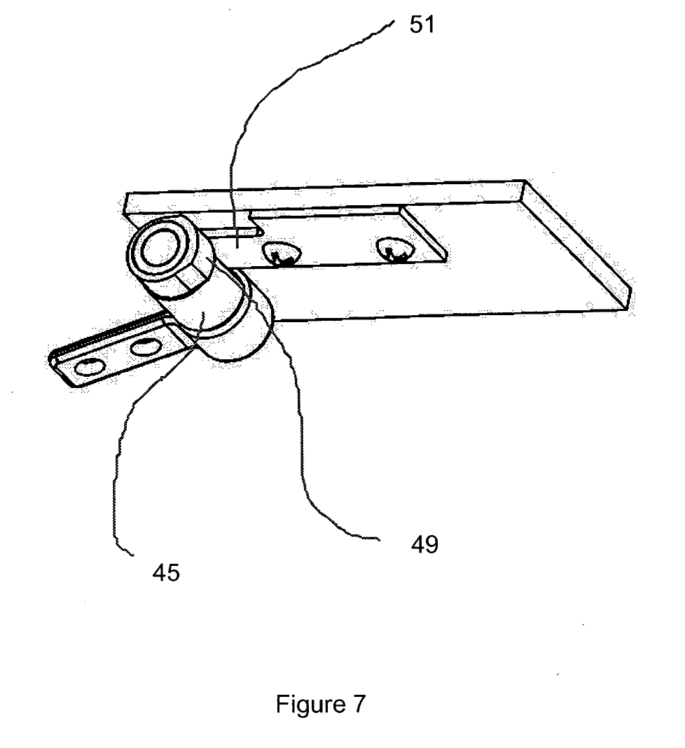

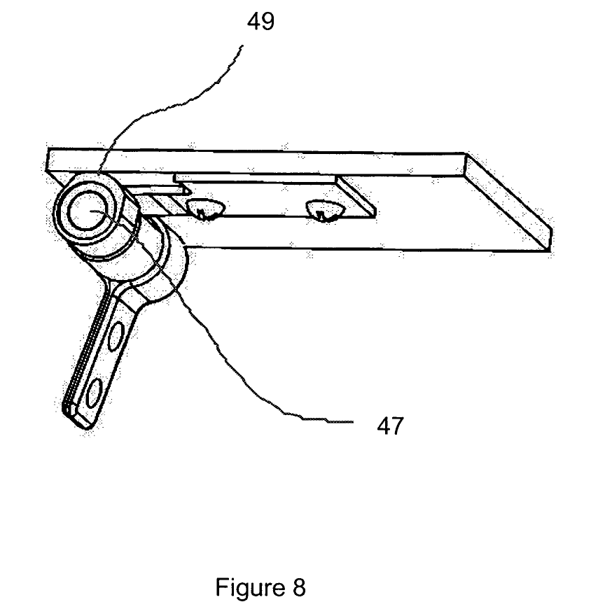

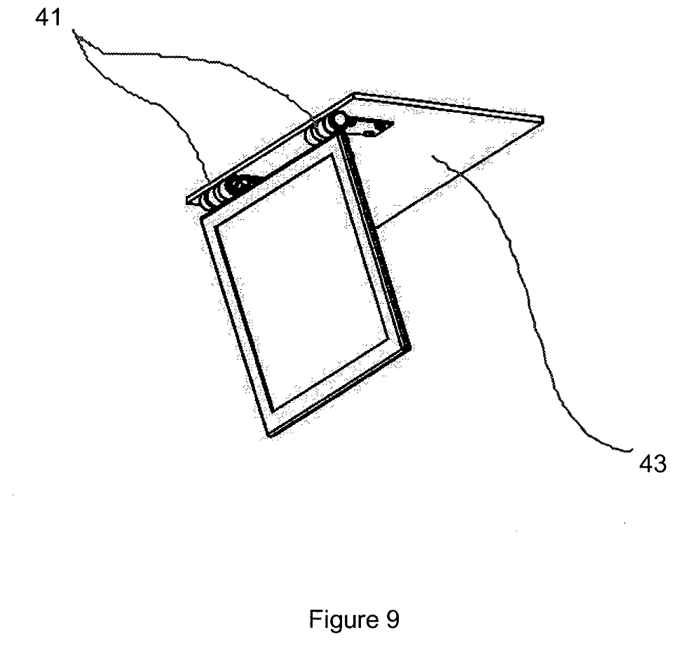

The alternative embodiment of our invention shown in FIGS. 6, 7, and 8 has hinge 41 mounted to plate 43 as might be used to mount a display as shown in FIG. 9. The two curved, bearing portions 45 of the band are shaped to fit snugly, but without interference, over the ends of shaft 47 to form bearings within which the shaft can rotate. Between the two bearing portions 45, shaft 47 has a surface formed into cam 49. Attached to shaft 47, is output adapter 48. The cross-sectional view shown in FIG. 7 makes this clearer. As output adapter 48 and shaft 47 rotate, as shown in FIG. 8, also a cross-sectional view, cam 49 contacts plate 43, causing shaft 47 to move away from plate 43. This is possible because the band is made of spring material and bearing portions 45 of the band are at the ends of extensions 51 that connect the curved portions to the body of the band. These extensions form the spring against which the cam forces shaft 47 away from plate 43, producing the desired friction.

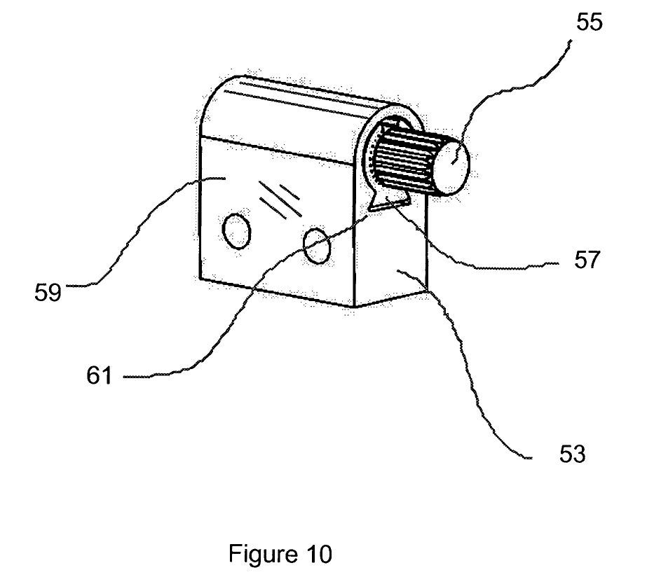

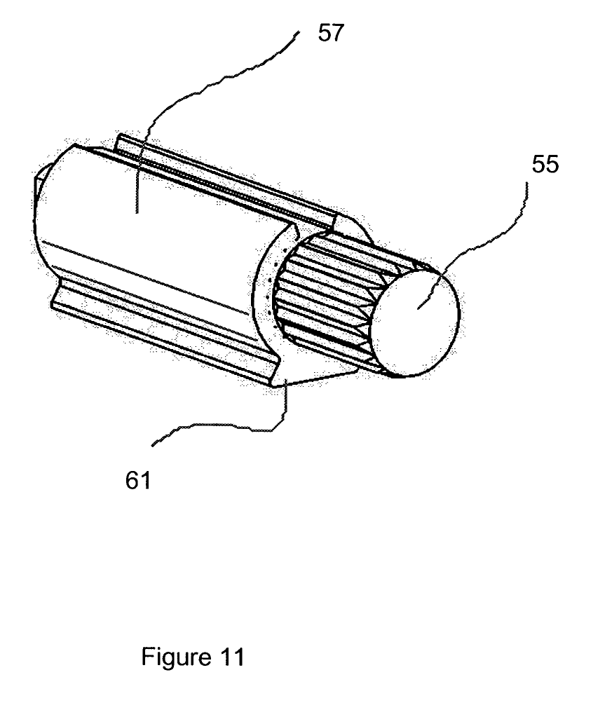

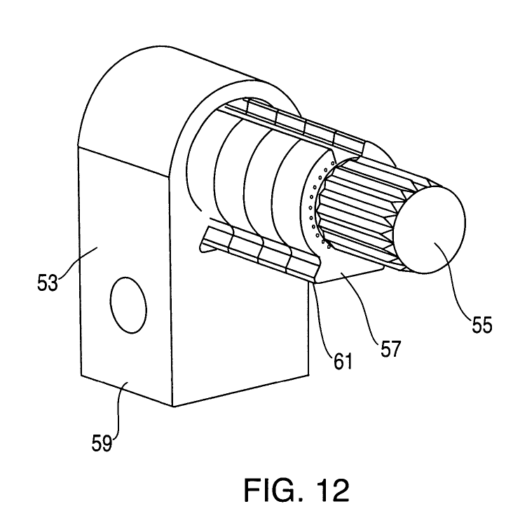

All of the embodiments shown have the desired compact structure combining viscous damping with friction in a package that is only slightly larger, if at all, then a state-of-the-art friction hinge. FIGS. 10, 11, and 12 show a hinge employing another method for achieving friction with viscous damping in a small package. Hinge 53 is comprised of annular element 55, friction clamp 57, and housing 59. Also present, as in the previously shown embodiments, but not shown are a shaft and means providing an irrotational connection between the shaft and housing 59. Friction clamp 57 and be a single piece as shown in FIG. 11, or a stack of shorter plates as shown in FIG. 12. In either case, friction clamp 57 moves with housing 59 because of a dovetail 61or other similar mechanism. As in the previously shown embodiments, viscous damping is due to the shear in the fluid between the shaft and the annular element.

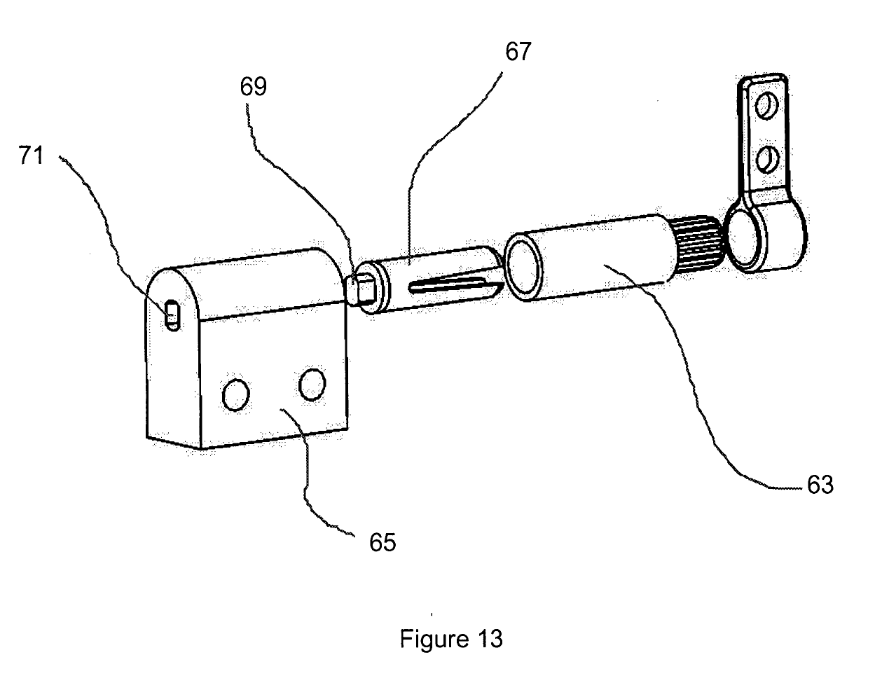

A still further embodiment is represented in FIG. 13. In this case the fluid shear that produces viscous damping takes place between the outer surface of annular element 63 and the interior surface of housing 65. Friction is achieved by the well known technique of a hairpin-like, split shaft 67 that is inserted into the co-axial hole in the center of annular element 63. As before, the inner and outer elements must be irrotationally connected. This is accomplished by shaped end 69 of shaft 67 which fits closely into shaped hole 71 in housing 65.

It will thus be seen that the objects set forth above among those made apparent from the preceding description, are efficiently attained and, since certain changes may be made in the construction of the inventive friction hinge without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

We claim:

1. A hinge assembly rotational coupling a first and a second components comprising:
a first member coupled to said first component and having a generally cylindrical first inner surface and a generally cylindrical first outer surface;
a second member coupled to said second component and having a generally cylindrical second inner surface frictionally engaging said first outer surface;
a third member having a generally cylindrical third outer surface, said third member being axially disposed within said first member, with said third outer surface defining an annular space with said first inner surface; and
a damping fluid disposed within said space and cooperating with said first and third members to generate a damping force resisting rotation between said two components, said damping force being proportional to the rotational velocity of said components.

2. The hinge assembly of claim 1 wherein said third member is irrotationally coupled to said second member.

3. The hinge assembly of claim 1 further comprising a first mounting member coupling said first member to the first component.

4. The hinge assembly of claim 1 further comprising a second mounting member coupling said second member to said second component.

5. The hinge of assembly of claim 1 wherein said second member is a question mark shaped band having a circular portion with said second inner surface and a straight portion mounting said second member to the second component.

6. The hinge assembly of claim 1 wherein said first outer surface is formed with several zones disposed at a variable distance from a hinge axis, said first and second members cooperating to generate an angularly dependent frictional torque as said components are rotated with respect to each other.

7. A hinge assembly connected to a first and a second component, comprising:
a shaft having a cylindrical outer surface and having a first end and a second end, said first end being coupled to said first component;
a first tubular member coupled to said second component and having an inner cylindrical surface, said shaft being disposed at least partially within said tubular member and forming an annular space between said shaft and said tubular member;
a viscous fluid disposed in said space to provide an effective damping force resisting rotation of said components; and
a second tubular member disposed over said first tubular member and forming a frictional fit with said first tubular member to provide frictional forces opposing relative movement between said components.

8. The hinge assembly of claim 7 wherein said shaft is irotationally attached to said first component and said first tubular member is irrotationally attached to said second component.

9. The hinge assembly of claim 7 wherein said shaft and said second component are irrotationally attached to said first component, and said first tubular member is irotationally attached to said second component.

10. The hinge assembly of claim 9 wherein said second tubular member includes a tubular portion telescopically disposed around said first tubular member and a straight section mounted on said first component.

11. The hinge assembly of claim 10 wherein said first end is engaged by said second component to prevent rotation between said shaft and said second component.

12. The hinge assembly of claim 10 further comprising a mounting member and said first tubular member has a third end received by said mounting member.

13. The hinge assembly of claim 12 wherein said mounting member has an aperture and said third end is press-fit into said aperture.

14. The hinge assembly of claim 7 wherein said viscous fluid is a grease.

15. The hinge assembly of claim 7 wherein said viscous fluid is a compound formed of lubricating oil and a filler.

16. The hinge assembly of claim 7 wherein said cylindrical surface is formed with several zones defining respective angular positions for said components.
